(19) United States
(12) Patent Application Publication
(10) Pub. No.: US 2013/0085200 A1
(43) Pub. Date: Apr. 4, 2013

(54) HIGH AIR FLOW POLYURETHANE VISCOELASTIC FOAM

(71) Applicants: Kaoru Aou, Lake Jackson, TX (US); Rogelio R. Gamboa, Brazoria, TX (US); Bernard E. Obi, Missouri City, TX (US); Asjad Shafi, Lake Jackson, TX (US)

(72) Inventors: Kaoru Aou, Lake Jackson, TX (US); Rogelio R. Gamboa, Brazoria, TX (US); Bernard E. Obi, Missouri City, TX (US); Asjad Shafi, Lake Jackson, TX (US)

(73) Assignee: DOW GLOBAL TECHNOLOGIES LLC, Midland, MI (US)

(21) Appl. No.: 13/702,273

(22) PCT Filed: Jun. 20, 2011
(86) PCT No.: PCT/US2011/041041

§ 371 Date: Dec. 5, 2012

Related U.S. Application Data
(60) Provisional application No. 61/357,612, filed on Jun. 23, 2010.

(51) Int. Cl. C08G 18/06

(52) U.S. Cl. CPC C08G 18/06
USPC 521/170

(57) ABSTRACT

Polyurethane foams and methods for making polyurethane foams are provided. The method may comprise forming a reaction mixture including a toluene diisocyanate (TDI) component, an isocyanate reactive component comprising one or more propylene oxide rich (PO-rich) polyols, one or more ethylene oxide rich (EO-rich) polyols having a combined number average equivalent weight from 100 to 500 comprising from 10% to 28% by weight of the total isocyanate reactive component, water, and a catalyst component comprising at least one catalyst, and subjecting the reaction mixture to conditions sufficient to result in the reaction mixture to expand and cure to form a viscoelastic polyurethane foam having a resilience of less than 25%, as measured according to ASTM D3574 Test H.

### BACKGROUND OF THE INVENTION

1. Field of the Invention

Embodiments of the present invention relate to polyurethane foams. More particularly, embodiments of the present invention relate to polyurethane foams having viscoelastic properties.

2. Description of the Related Art

Polyurethane foams are used in a wide variety of applications, ranging from cushioning (such as mattresses, pillows and seat cushions) to packaging to thermal insulation and for medical applications. Polyurethanes have the ability to be tailored to particular applications through the selection of the raw materials that are used to form the polymer. Rigid types of polyurethane foams are used as appliance insulation foams and other thermal insulating applications. Semi-rigid polyurethanes are used in automotive applications such as dashboards and steering wheels. More flexible polyurethane foams are used in cushioning applications, notably furniture, bedding and automotive seating.

One class of polyurethane foam is known as viscoelastic (VE) or “memory” foam. Viscoelastic foams exhibit a time-delayed and rate-dependent response to an applied stress. They have low resiliency and recover slowly when compressed. These properties are often associated with the glass transition temperature (Tg) of the polyurethane. Viscoelasticity is often manifested when the polymer has a Tg at or near the use temperature, which is room temperature for many applications.

Like most polyurethane foams, VE polyurethane foams are prepared by the reaction of a polyol component with a polyisocyanate, in the presence of a blowing agent. The blowing agent is usually water or, less preferably, a mixture of water and another material. VE formulations are often characterized by the selection of polyol component and the amount of water in the formulation. The predominant polyol used in these formulations has a functionality of about 3 hydroxyl groups/molecule and a molecular weight in the range of 400-1500. This polyol is primarily the principal determinant of the Tg of the polyurethane foam, although other factors such as water levels and isocyanate index also play significant roles.

Typically viscoelastic polyurethane foams have low air flow properties, generally less than about 1.0 standard cubic feet per minute (scfm) (0.47 liters/second) under conditions of room temperature (22° C.) and atmospheric pressure (1 atm), therefore promoting sweating when used as comfort foams (for instance, bedding, seating and other cushioning). Low airflow also leads to low heat and moisture transfer out of the foam resulting in (1) increased foam (bed) temperature and (2) moisture level. The consequence of higher temperature is higher resiliency and lowered viscoelastic character. Combined heat and moisture result in accelerated fatigue of the foam. In addition, if foam air flows are sufficiently low, foams can suffer from shrinkage during manufacturing. Furthermore, improving the support factor of viscoelastic foams is limited unless viscoelastic properties are compromised. These disadvantages are sometimes addressed by addition of copolymer polyols such as those containing styrene/acrylonitrile (SAN).

It would be desirable to achieve a higher air flow value than is generally now achieved while retaining viscoelastic properties of the foam. Furthermore, it would be desirable to have foams with good air flow while improving the support factor. In some applications, it is also desirable to have foams which feel soft to the touch.

### SUMMARY OF THE INVENTION

Embodiments of the present invention relate to polyurethane foams. More particularly, embodiments of the present invention relate to polyurethane foams having high air flow while maintaining viscoelastic properties.

In one embodiment, a reaction system for preparation of a viscoelastic polyurethane foam is provided. The reaction system comprises (a) a toluene diisocyanate (TDI) component, (b) an isocyanate reactive component, and (c) a catalyst component. The isocyanate reactive component (b) comprises (i) from 70% to 90% by weight of the isocyanate reactive component of one or more propylene oxide rich (PO-rich) based polyols the one or more PO-rich polyols having a combined number average equivalent weight from 300 to 500, and (ii) from 10% to 28% by weight of the isocyanate reactive component of one or more ethylene oxide rich (E0-rich) based polyols having a combined number average equivalent weight from 150 to 500, and (iii) from 1% to 5% by weight of the isocyanate reactive component of water.

In another embodiment, a method of preparing a viscoelastic foam is provided. The method comprises forming a reaction mixture including a toluene diisocyanate (TDI) component, an isocyanate reactive component comprising one or more propylene oxide rich (PO-rich) polyols, one or more ethylene oxide rich (EO-rich) polyols having a combined number average equivalent weight from 175 to 400 comprising from 10% to 28% by weight of the total isocyanate reactive component, water, and a catalyst component comprising at least one catalyst, and subjecting the reaction mixture to conditions sufficient to result in the reaction mixture to expand and cure to form a viscoelastic polyurethane foam having a resilience of less than 25%, as measured according to ASTM D3574 Test H.

### DETAILED DESCRIPTION

Embodiments of the present invention relate to polyurethane foams. More particularly, embodiments of the present invention relate to polyurethane foams having high air flow while maintaining viscoelastic properties.

As used herein, the term “viscoelastic foam” is intended to designate those foams having a resilience of less than 25%, as measured according to ASTM D3574 Test H. Preferably the foam will have a resilience of less than 20%. In certain embodiments the foam will have a resilience of less than 15% or even less than 10%.

The term “resiliency” is used to refer to the quality of a foam perceived as springiness. It is measured according to the procedures of ASTM D3574 Test H. This ball rebound test measures the height a dropped steel ball of known weight rebounds from the surface of the foam when dropped under specified conditions and expresses the result as a percentage of the original drop height. As measured according to the ASTM test, a cured VE foam exhibits a resiliency of advantageously at most about 20%, preferably at most about 10%.

As used herein, the term “support factor” refers to the ratio of 65% Compression (Indentation) Force Deflection (CFD) divided by 25% Compression Force Deflection. The term “Compression Force Deflection” refers to a measure of the load bearing capacity of a flexible material (for instance, foam) measured as the force (in pounds) (0.4536 kgf) required to compress a four inch (10 cm) thick sample no smaller than 24 inches square (155 cm²), to 25 or 65 percent of the sample's initial height as indicated by the terms 25% CFD and 65% CFD, respectively.

The term “density” is used herein to refer to weight per unit volume of a foam. In the case of viscoelastic polyurethane foams the density is determined according to the procedures of ASTM D357401, Test A. Advantageously, the viscoelastic foam has a density of at least about 3, preferably at least about 3.5, more preferably at least about 4 and preferably at most about 8, more preferably at most about 6, most preferably at most about 5.5 pounds/ft³ (48, 56, 64, 128, 96, 88 kg/m³, respectively).

The term “tensile strength” as applied to a foam is used herein to refer to the maximum force which a dogbone shaped foam sample can bear while being extended under linear (uniaxial) extensional force. The stress is increased until the material reaches a break point at which time the load and extension at break are used to calculate the tensile strength and the elongation, all determined according to the procedures of ASTM D-3574, Test E and is measured in pounds per square inch (psi) or kilopascals (kPa).

The term “% elongation” as applied to a foam is used herein to refer to the linear extension which a sample of foam can attain before rupture. The foam is tested by the same method used to determine tensile strength, and the result is expressed as a percentage of the original length of the foam sample according to the procedures of ASTM D-3574, Test E.

The term “tear strength” is used herein to refer to the maximum average force required to tear a foam sample which is pre-notched with a slit cut lengthwise into the foam sample. The test results are determined according to the procedures of ASTM D3574-F in pounds per linear inch (lb_{f}/in) or in newtons per meter (N/m).

The term “CFD 25%” is used herein to refer to the force required to displace a foam sample of dimensions 4 in×4 in×2 in thickness (10.16×10.16×5.08 cm) to 75% of its original thickness determined according to the procedures of ASTM D 3574 C and is measured in pounds force (lb_{f}) or in newtons (N). Similarly CFD 65% and CFD 75% refer to the forces required to compress a foam of dimension (4 in×4 in×2 in thickness) (10.16×10.16×5.08 cm) to 35% or 25% of its original foam height, respectively.

The term “recovery time” is used herein to refer to the time it takes a foam to recover after compression, an applied force of 1 pound of force (4.45 N), which is determined according to the procedures of ASTM D-3574M and is measured in seconds. For a viscoelastic foam this time is desirably at least about 3 seconds, preferably at least about 5 seconds, more preferably at least about 7 seconds, and most preferably at least about 10 seconds, but advantageously less than about 30 seconds and preferably less than about 20 seconds.

The term “Compression Set@75%” stands for compression set test measured at the 75% compressive deformation level and parallel to the rise direction in the foam. This test is used herein to correlate in-service loss of cushion thickness and changes in foam hardness. The compression set is determined according to the procedures of ASTM D 3574-95, Test I. and is measured as percentage of original thickness of the sample. Similarly, “Compression Set@90%” refers to the same measurement as above (compression set), but this time measured at 90% compressive deformation level of the sample, parallel to the rise direction in the foam.

The term “air flow” refers to the volume of air which passes through a 1.0 inch (2.54 cm) thick 2 inch x 2 inch (5.08 cm) square section of foam at 125 Pa (0.018 psi) of pressure. Units are expressed in cubic decimeters per second (i.e. liters per second) and converted to standard cubic feet per minute. A representative commercial unit for measuring air flow is manufactured by TexTest AG of Zurich, Switzerland and identified as TexTest Fx3300. This measurement follows ASTM D 3574 Test G.

The term “hardness” refers to that property measured by the procedures of ASTM D 3574, Test C which corresponds to CFD.

The term “NCO Index” means isocyanate index, as that term is commonly used in the polyurethane art. As used herein the term “NCO Index” is the equivalents of isocyanate, divided by the total equivalents of isocyanate-reactive hydrogen containing materials, multiplied by 100.

As used herein, “polyol” refers to an organic molecule having an average of greater than 1.0 hydroxyl groups per molecule. A polyol may also include other functionalities, that is, additional types of functional groups.

As used herein the term “polyether polyol” is a polyol formed from at least one alkylene oxide, preferably ethylene oxide, propylene oxide or a combination thereof, a polyol of the type commonly used in making polyurethane foams, particularly for the practice of embodiments of this invention, viscoelastic polyurethane foams

The term “hydroxyl number” indicates the concentration of hydroxyl moieties in a composition of polymers, particularly polyols. A hydroxyl number represents mg KOH/g of polyol, as measured by ASTM method D4274.

The term “functionality” particularly “polyol functionality” is used herein to refer to the number of active hydrogens on an initiator, used to prepare the polyol, that can react with an epoxide molecule (such as ethylene oxide or propylene oxide). This is also referred to as nominal functionality.

The isocyanate-reactive components used in polyurethane production are generally those compounds having at least two hydroxyl groups. Those compounds are referred to herein as polyols. The polyols include those obtained by the alkoxylation of suitable starting molecules (initiators) with an alkylene oxide. Examples of initiator molecules having 2 to 4 reactive sites include water, ammonia, or polyhydric alcohols such as dihydric alcohols having a molecular weight from 62 to 399, especially the alkane polyols such as ethylene glycol, propylene glycol, hexamethylene diol, glycerol, trimethylol propane or trimethylol ethane, or low molecular weight alcohols containing ether groups such as diethylene glycol, triethylene glycol, dipropylene glycol, tripropylene glycol or butylene glycols. These polyols are conventional materials prepared by conventional methods. Catalysis for this polymerization can be either anionic or cationic, with catalysts such as KOH, CsOH, boron trifluoride, or a double metal cyanide complex (DMC) catalyst such as zinc hexacyanocobaltate or quaternary phosphazenium compound. In the case of alkaline catalysts, these alkaline catalysts are preferably removed from the polyol at the end of production by a proper finishing step, such as coalescence, magnesium silicate separation or acid neutralization.

In one embodiment described herein the viscoelastic foam is a reaction product of a reaction system where the reaction system includes (a) a toluene diisocyanate component, (b) an isocyanate reactive component comprising (i) from 70% to 90% by weight of the isocyanate reactive component of one or more PO-rich polyols having a combined number average equivalent weight from 300 to 500, and (ii) from 10% to 28% by weight of the isocyanate reactive component of one or more EO-rich polyols having a combined number average equivalent weight from 150 to 500. In certain embodiments, the isocyanate reactive component further comprises (iii) from 1% to 5% by weight of water. In certain embodiments, the reaction system further comprises (c) a catalyst component comprising one or more catalysts. In certain embodiments, the reaction system further comprises (d) an organosilicone surfactant. In certain embodiments, the reaction system further comprises (e) additional additives.

Component (a) comprises one or more toluene diisocyanates having an average of 1.8 or more isocyanate groups per molecule. The isocyanate functionality is preferably from about 1.9 to 4, and more preferably from 1.9 to 3.5 and especially from 1.9 to 2.5. Exemplary polyisocyanates include, for example, 2,4- and/or 2,6-toluene diisocyanate (TDI). Preferred polyisocyanates include mixtures of the 2,4- and 2,6-isomers of TDI. A polyisocyanate of particular interest is a mixture of 2,4- and 2,6-toluene diisocyanate containing at least 60% by weight of the 2,4-isomer. In another embodiment, the polyisocyanate is a mixture of 2,4- and 2,6-toluene diisocyanate containing at about 80% by weight of the 2,4-isomers. These polyisocyanate mixtures are widely available and are relatively inexpensive, yet have heretofore been difficult to use in commercial scale VE foam processes due to difficulties in processing the foam formulation.

The amount of polyisocyanate that is used typically is sufficient to provide an isocyanate index of from 70 to 130. In another the index is from 80 to 115 and in a further embodiment from 85 to 105.

Component (b) is an isocyanate reactive component comprising (i) one or more PO-rich polyols, the one or more PO-rich polyols having a combined number average equivalent weight from 300 to 500, (ii) one or more EO-rich polyols having a number average equivalent weight from 150 to 500, and (iii) water. The one or more PO-rich polyols comprise from 70% to 90% by weight of the isocyanate reactive component and the one or more EO-rich polyols comprise from 10% to 28% by weight of the isocyanate reactive component.

In certain embodiments, the one or more PO-rich polyols will comprise at least 70 wt %, 75 wt %, or 80 wt % of the total isocyanate reactive component (b). In certain embodiments, the one or more PO-rich polyols will comprise up to at least 75 wt %, 80 wt %, 85 wt %, or up to 90 wt % of the total isocyanate reactive component (b). In certain embodiments, the one or more PO-rich polyols may comprise from 70% to 90% by weight or from about 75% to 85% by weight of the total isocyanate reactive component (b).

In certain embodiments, the one or more EO-rich polyols may comprise at least 10 wt %, 14 wt %, 20 wt %, or 25 wt % of the total isocyanate reactive component (b). In certain embodiments, the one or more EO-rich polyols may comprise up to at least 20 wt %, 25 wt %, or 28 wt %. The one or more EO-rich polyols may comprise from 10% to 28% by weight or from 15% to 25% by weight of the total isocyanate reactive component (b).

In one embodiment described herein, the isocyanate reactive component (b) comprises one or more PO-rich polyols, each PO-rich polyol having a number average equivalent weight between 200 and 2,000 and a number average nominal hydroxyl functionality of 2-4; and one or more EO-rich polyols, each EO-rich polyol having a number average equivalent weight between 100 and 1,000, and a number average nominal hydroxyl functionality of 2-4. In certain embodiments, the isocyanate reactive component (b) comprises one or more PO-rich polyols having a combined number average equivalent weight between 300 and 500. In certain embodiments, the isocyanate reactive component (b) comprises one or more PO-rich polyols having a combined number average equivalent weight between 325 and 450. In certain embodiments, the isocyanate reactive component (b) comprises one or more EO-rich polyols having a combined number average equivalent weight between 150 and 500. In certain embodiments, the isocyanate reactive component (b) comprises one or more EO-rich polyols having a combined number average equivalent weight between 175 and 400.

In one embodiment, described herein, less than 28% of all polyoxyalkylene units on the polyols of the reaction system are oxyethylene units. In another embodiment, less than 25% of all polyoxyalkylene units on the polyols of the reaction system are oxyethylene units.

In certain embodiments, the one or more PO-rich polyols will generally contain greater than 70% by weight of propylene oxide and preferably at least 75% by weight of propylene oxide. In other embodiments the polyols will contain greater than 80 wt % of propylene oxide and in a further embodiment, 85 wt % or more of the one or more PO-rich polyols will be derived from propylene oxide. In some embodiments, propylene oxide will be the sole alkylene oxide used in the production of the polyol. When ethylene oxide (EO) is used in the production of the propylene oxide based polyol, it is preferred the EO is fed as a co-feed with the PO or fed as an internal block.

It should be further understood that although predominantly rich in oxypropylene units, the one or more PO-rich polyols may contain a mixture of both propylene oxide and ethylene oxide. In certain embodiments, the PO-rich polyol contains greater than at least 70% by weight of propylene oxide units, more preferably at least 75% propylene oxide, more preferably at least 80% propylene oxide, still in a further embodiment at least 90%, and even at least 93% propylene oxide by weight.

In certain embodiments, the isocyanate reactive component comprises one or more EO-rich polyols having a functionality of between 2 and 4 and a combined number average equivalent weight of between 100 and 300, one or more PO-rich polyols having a functionality of between 2 and 4 and a combined number average equivalent weight of between 200 and 400, and one or more glycerin initiated polyoxyethylene-polyoxypropylene polyols having a functionality of between 2 and 4 and a number average equivalent weight of between 800 and 1100.

In certain embodiments, the one or more PO-rich polyols comprise one or more PO-rich polyols having a functionality of 3 and a combined number average equivalent weight of between 300 and 350 and one or more PO-rich polyols having a functionality of 3 and a combined number average equivalent weight of between 200 and 250.

In certain embodiments, isocyanate reactive component (b) comprises multiple PO-rich polyol components (i), for example, at least one PO-rich polyol having a number average equivalent weight of less than 700 (iA) and at least one second PO-rich polyol having an equivalent weight of 700 or greater (iB). The polyol components may independently contain weight percents derived from PO as described above.

In certain embodiments, when two separate PO-rich polyols (iA) and (iB) are used, the first PO-rich polyol component (iA) will generally comprise at least 35 wt %, 40 wt % or at least 45 wt % of the total isocyanate reactive component (b). The first PO-rich polyol component (iA) may comprise at least 50 wt %, 55 wt %, 60 wt % and even up to 84 wt % of the total isocyanate reactive component (b). The equivalent weight of polyol (iA) will generally be from 100 to less than 700 and preferably from 150 to 650. In certain embodiments, the equivalent weight is from 300 to 650.

When both PO-rich polyols (iA) and (iB) are present, polyol (iB) will generally comprise at least 1 wt %, at least 3 wt % or at least 5 wt % of the total polyol. Polyol (iB) will generally comprise less than 30 wt %, preferably less than 20 wt % or even less than 10 wt % of the total isocyanate reactive component. The equivalent weight of polyol (iB) is from 700 to 2,000. Preferably the equivalent weight of polyol (iB) is from 750 to 1,750. In certain embodiments, the equivalent weight of polyol (iB) is from 800 to 1,450. In certain embodiments the equivalent weight of polyol (iB) is less than 1,250.

In certain embodiments, the one or more PO-rich polyols (i) comprise, for example, three separate components; at least one polyol having a number average equivalent weight from 300 to 700 (iA), at least one second polyol having an equivalent weight of 700 or greater (iB), and at least one third polyol having an equivalent weight of less than 300 (iC). The polyol components (iA), (iB), and (iC) may independently contain weight percents derived from PO as described above.

When three polyols (iA), (iB), and (iC) are used, the polyol component (iA) will generally comprise at least 35 wt %, 40 wt % or at least 45 wt % of the total isocyanate reactive component (b). Polyol component (iA) may comprise at least 50 wt %, 55 wt %, 60 wt % and even up to 83 wt % of the total isocyanate reactive component (b).

When three polyols (iA), (iB), and (iC) are present, polyol (iB) will generally comprise at least 1 wt %, at least 3 wt % or at least 5 wt % of the total isocyanate reactive component (b). Polyol (iB) will generally comprise less than 30 wt %, preferably less than 20 wt % or even less than 10 wt % of the total isocyanate reactive component (b).

When three polyols (iA), (iB), and (iC) are present, polyol (iC) will generally comprise at least 1 wt %, at least 3 wt % or at least 5 wt % of the total isocyanate reactive component (b). Polyol (iB) will generally comprise less than 60 wt %, preferably less than 20 wt % or even less than 10 wt % of the total polyol present. The equivalent weight of polyol (iC) will generally be from 100 to less than 700 and preferably from 150 to 650. In other embodiments, the equivalent weight is from 200 to less than 300.

Polyol (ii) is an ethylene oxide rich polyol containing greater than 70% by weight of ethylene oxide, preferably at least 75% by weight of ethylene oxide, more preferably at least 80% ethylene oxide, still in a further embodiment at least 90%, and even at least 93% ethylene oxide by weight. In some embodiments, (bii) is essentially free of alkylene oxides other than ethylene oxide. Polyol (bii) generally has a nominal functionality of bound hydroxyl groups of 2 to 4, preferably 2 to 3, and in some embodiments a nominal functionality of 3.

The number average equivalent weight of (bii) relative to the combined total of hydroxyl groups in the polyol, is from 100 to 1,000; and in some embodiments from 150 to 500, and even from 175 to less than 400.

In certain embodiments, the isocyanate reactive component (b) further comprises water (ii), in an amount from about 0.5 to about 5 parts per 100 total polyol (pphp). In certain embodiments, the water content is from about 0.8 to about 2 parts, especially from 1.0 to 2.25 parts, and in a further embodiment from 0.8 to 1.8 parts, by weight per 100 parts by weight total polyol. In certain embodiments, the water content is from 1% to 5% by weight of the isocyanate reactive component. In certain embodiments, the water content is from 1% to 2% by weight of the total isocyanate reactive component (b).

The reaction system may optionally contain minor amounts of up to 10% by weight of the total reaction system (but typically zero or up to less than 5 wt %) of reactive (polymer forming) species, not including any chain extenders, cross linkers or reactive fillers as described herein, other than those specified above. These may include, for example, species containing primary and/or secondary amines, polyester polyols or polyols different than those described above.

A wide variety of materials are known to catalyze polyurethane forming reactions, including tertiary amines; tertiary phosphines such as trialkylphosphines and dialkylbenzylphosphines; various metal chelates such as those which can be obtained from acetylacetone, benzoylacetone, trifluoroacetyl acetone, ethyl acetoacetate and the like, with metals such as Be, Mg, Zn, Cd, Pd, Ti, Zr, Sn, As, Bi, Cr, Mo, Mn, Fe, Co and Ni; acid metal salts of strong acids, such as ferric chloride, stannic chloride, stannous chloride, antimony trichloride, bismuth nitrate and bismuth chloride; strong bases such as alkali and alkaline earth metal hydroxides, alkoxides and phenoxides, various metal alcoholates and phenolates such as Ti(OR)₄, Sn(OR)₄ and Al(OR)₃, wherein R is alkyl or aryl, and the reaction products of the alcoholates with carboxylic acids, beta-diketones and 2-(N,N-dialkylamino)alcohols; alkaline earth metal, Bi, Pb, Sn or Al carboxylate salts; and tetravalent tin compounds, and tri- or pentavalent bismuth, antimony or arsenic compounds. Preferred catalysts include tertiary amine catalysts and organotin catalysts. Examples of commercially available tertiary amine catalysts include: trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, triethylenediamine and dimethylalkylamines where the alkyl group contains from 4 to 18 carbon atoms. Mixtures of these tertiary amine catalysts are often used.

Examples of commercially available amine catalysts include Niax™ A1 and Niax™ A99 (bis(dimethylaminoethyl)ether in propylene glycol available from Momentive Performance Materials), Niax™ B9 (N,N-dimethylpiperazine and N-N-dimethylhexadecylamine in a polyalkylene oxide polyol, available from Momentive Performance Materials), Dabco™ 8264 (a mixture of bis(dimethylaminoethyl)ether, triethylenediamine and dimethylhydroxyethyl amine in dipropylene glycol, available from Air Products and Chemicals), and Dabco™ 33LV (triethylene diamine in dipropylene glycol, available from Air Products and Chemicals), Niax™ A-400 (a proprietary tertiary amine/carboxylic salt and bis (2-dimethylaminoethy)ether in water and a proprietary hydroxyl compound, available from Momentive Performance Materials); Niax™ A-300 (a proprietary tertiary amine/carboxylic salt and triethylenediamine in water, available from Momentive Performance Materials); Polycat™ 58 (a proprietary amine catalyst available from Air Products and Chemicals), Polycat™ 5 (pentamethyl diethylene triamine, available from Air Products and Chemicals) and Polycat™ 8 (N,N-dimethyl cyclohexylamine, available from Air Products and Chemicals). In certain embodiments, the amine catalyst may be present in amounts from 0.01 to 1.0 pphp, preferably from 0.15 to 0.5 pphp.

Examples of organotin catalysts are stannic chloride, stannous chloride, stannous octoate, stannous oleate, dimethyltin dilaurate, dibutyltin dilaurate, other organotin compounds of the formula SnRₙ(OR)₄₋ₙ, wherein R is alkyl or aryl and n is 0-2, and the like. Organotin catalysts are generally used in conjunction with one or more tertiary amine catalysts, if used at all. Commercially available organotin catalysts of interest include KOSMOS™ 29 (stannous octoate from Evonik AG), Dabco™ T-9 and T-95 catalysts (both stannous octoate compositions available from Air Products and Chemicals). In certain embodiments, the tin based catalyst may be present in amounts of 0 to 0.5 pphp, preferably 0 to 0.05 pphp.

Catalysts are typically used in small amounts, for example, each catalyst being employed from about 0.0015 to about 5% by weight of the total reactive system. The amount depends on the catalyst or mixture of catalysts, the desired balance of the gelling and blowing reactions for specific equipment, the reactivity of the polyols and isocyanate as well as other factors familiar to those skilled in the art.

In a further embodiment, to improve processing and to permit the use of higher isocyanate indices, additives such as those described in publication WO 20008/021034, the disclosure of which is incorporated herein by reference, may be added to the reaction mixture. Such additives include 1) alkali metal or transition metal salts of carboxylic acids; 2) 1,3,5-tris alkyl- or 1,3,5-tris (N,N-dialkyl amino alkyl)- hexahydro-s-triazine compounds; and 3) carboxylate salts of quaternary ammonium compounds. When used, such additives are generally used in an amount from about 0.01 to 1 part per 100 total polyol. The component e) additive is generally dissolved in at least one other component of the reaction mixture. It is generally not preferred to dissolve it in the polyisocyanate.

Various additional components may be included in the viscoelastic foam formulation. These include, for example, chain extenders, crosslinkers, surfactants, plasticizers, fillers, plasticizers, smoke suppressants, fragrances, reinforcements, dyes, colorants, pigments, preservatives, odor masks, physical blowing agents, chemical blowing agents, flame retardants, internal mold release agents, biocides, antioxidants, UV stabilizers, antistatic agents, thixotropic agents, adhesion promoters, cell openers, and combination of these.

The foamable composition may contain a cell opener, chain extender or crosslinker. When these materials used, they are typically used in small quantities such as up to 10 parts, especially up to 2 parts, by weight per 100 parts by weight of the total reactive system. A chain extender is a material having two isocyanate-reactive groups/molecule, whereas a crosslinker contains on average greater than two isocyanate-reactive groups/molecule. In either case, the equivalent weight per isocyanate-reactive group can range from about 30 to less than 100, and is generally from 30 to 75. The isocyanate-reactive groups are preferably aliphatic alcohol, primary amine or secondary amine groups, with aliphatic alcohol groups being particularly preferred. Examples of chain extenders and crosslinkers include alkylene glycols such as ethylene glycol, 1,2- or 1,3-propylene glycol, 1,4-butanediol, 1,6-hexanediol, and the like; glycol ethers such as diethylene glycol.

Examples of cell openers include, for example, butylene oxide rich polyols and natural oil polyols. In certain embodiments, the cell openers may be present in amounts of 0 to 1 pphp.

A surfactant may be included in the viscoelastic foam formulation to help stabilize the foam as it expands and cures. Examples of surfactants include nonionic surfactants and wetting agents such as those prepared by the sequential addition of propylene oxide and then ethylene oxide to propylene glycol, solid or liquid organosilicones, and polyethylene glycol ethers of long chain alcohols. Ionic surfactants such as tertiary amine or alkanolamine salts of long chain alkyl acid sulfate esters, alkyl sulfonic esters and alkyl arylsulfonic acids may also be used. The surfactants prepared by the sequential addition of propylene oxide and then ethylene oxide to propylene glycol are preferred, as are the solid or liquid organosilicones. Examples of useful organosilicone surfactants include commercially available polysiloxane/polyether copolymers such as Tegostab (trademark of Evonik AG) B-8462 and B-8404, and DC- 198 and DC-5043 surfactants, available from Dow Corning, and Niax™ L-627, L-618, and L-620 surfactant from Momentive Performance Materials. In certain embodiments, the surfactant may be present in amounts of 0.1 to 5 pphp, preferably 0.6 to 1.5 pphp.

One or more fillers may also be present in the viscoelastic foam formulation. A filler may help modify the composition's rheological properties in a beneficial way, reduce cost and impart beneficial physical properties to the foam. Suitable fillers include particulate inorganic and organic materials that are stable and do not melt at the temperatures encountered during the polyurethane-forming reaction. Examples of suitable fillers include kaolin, montmorillonite, calcium carbonate, mica, wollastonite, talc, high-melting thermoplastics, glass, fly ash, carbon black titanium dioxide, iron oxide, chromium oxide, azo/diazo dyes, phthalocyanines, dioxazines and the like. The filler may impart thixotropic properties to the foamable polyurethane composition. Fumed silica is an example of such a filler.

Reactive particles may also be included in the reaction system to modify the properties of the viscoelastic foam. Such reactive systems include copolymer polyols such as those containing styrene/acrylonitrile (SAN), polyharnstoff dispersion (PHD) polyols and polyisocyanate polyaddition products (PIPA), for instance as taught in Chemistry and Technology of Polyols for Polyurethanes, Rapra Technology Limited (2005) pp 185-227.

When used, fillers advantageously constitute from about 0.5 to about 30%, especially about 0.5 to about 10%, by weight of the composition.

Although no additional blowing agent (other than the water) in the foamable polyurethane composition is generally used, it is within the scope of the invention to include an additional physical or chemical blowing agent. Among the physical blowing agents are liquid CO₂, supercritical CO₂ and various hydrocarbons, fluorocarbons, hydrofluorocarbons, chlorocarbons (such as methylene chloride), chlorofluorocarbons and hydrochlorofluorocarbons. Chemical blowing agents are materials that decompose or react (other than with isocyanate groups) at elevated temperatures to produce carbon dioxide and/or nitrogen.

The VE foam can be prepared in a so-called slabstock process, or by various molding processes. In a slabstock process, the components are mixed and poured into a trough or other region where the formulation reacts, expands freely in at least one direction, and cures. Slabstock processes are generally operated continuously at commercial scales.

In a slabstock process, the various components are introduced individually or in various subcombinations into a mixing head, where they are mixed and dispensed. Component temperatures are generally in the range of from 15 to 35° C. prior to mixing. The dispensed mixture typically expands and cures without applied heat. In the slabstock process, the reacting mixture expands freely or under minimal restraint (such as may be applied due to the weight of a cover sheet or film).

It is also possible to produce the viscoelastic foam in a molding process, by introducing the reaction mixture into a closed mold where it expands and cures. Often times, the mold itself is pre-heated to a temperature above ambient conditions. Such pre-heating of the mold can lead to faster cycle time.

Viscoelastic foam made in accordance with the invention are useful in a variety of packaging and cushioning applications, such as mattresses, including mattress toppers, pillows, packaging, bumper pads, sport and medical equipment, helmet liners, pilot seats, earplugs, and various noise and vibration dampening applications. The noise and vibration dampening applications are of particular importance for the transportation industry, such as in automotive applications.

The following examples are provided to illustrate the invention, but are not intended to limit the scope thereof. All parts and percentages are by weight unless otherwise indicated.

A description of the raw materials used in the examples is as follows.

Polyol A is a 3 functional, glycerine initiated, 336 equivalent weight all propylene oxide polyether polyol commercially available from The Dow Chemical Company under the trade designation VORANOL™ 3150.

Polyol B is a 3 functional, glycerine initiated, 236 equivalent weight all propylene oxide polyether polyol commercially available from the Dow Chemical Company under the trade designation VORANOL™I 2070 polyol.

Polyol C is a 3 functional, glycerine initiated polyoxyethylene-polyoxypropylene mixed fed polyol (8 wt % EO) having an equivalent weight of approximately 994 available from The Dow Chemical Company under the trade designation VORANOL™ 3010 polyol.

Polyol D is a 3 functional, glycerine initiated all ethylene oxide feed polyol, with an EW of approximately 208, available from The Dow Chemical Company under the trade designation VORANOL™ IP 625 polyol.

Polyol E is a 6.9 functional, 1800 approximate equivalent weight random copolymer of ethylene oxide and propylene oxide commercially available from The Dow Chemical Company under the trade designation VORANOL™ 4053 polyol.

Surfactant A is an organosilicone surfactant sold commercially by OSi Specialties as Niax™ L-627 surfactant.

Amine catalyst A is a 70% bis-dimethylaminoethyl ether solution in dipropylene glycol, commercially supplied as DABCO™ BL-11 catalyst available from Air Products and Chemicals, Inc.

Amine catalyst B is a 33% solution of triethylene diamine in dipropylene glycol, available commercially from Air Products and Chemicals as DABCO™ 33 LV.

Tin Catalyst A is a stannous octoate catalyst available commercially from Evonik AG as KOSMOS™ 29.

TDI-80 is an 80/20 blend of the 2,4- and 2,6-isomers of toluene diisocyanate available from The Dow Chemical Company under the trade designation VORANATE™ T-80.

### TEST METHODS

Unless otherwise specified, the foam properties are measured by ASTM 3574-05.

### Example 1 to 7 and Control (C1)

The foams were prepared under a fume hood in open boxes of dimension 15″×15″×9.5″ (square lateral dimension), lined with a clear plastic bag. The total formulation weights were fixed at 2,500 grams. Three mixing stages were used. The foams were prepared by first blending the polyols, water, amine catalysts, and surfactant in a high shear rate mix head. This mixture was then blended in the same manner with the tin catalyst, and the resulting mixture was blended, again in the same manner, with the polyisocyanate. The final blend was immediately poured into the open box and allowed to react without applied heat. Total formulation weights were 2,500 grams. Formulations used for producing polyurethane foam are given in Table 1. Example C1 is a control foam based on a formulation for production of a viscoelastic foam.

Foam samples were characterized according to ASTM D 3574. Compression Force Deflection “CFD” tests were performed on 4″×4″×2″ foam sample pieces. The properties of the produced foams are given in Table 2.

The data shows foams based on embodiments described herein have good (high) air flow, good (low) resiliency, and good (low) compression set values.

TABLE 1
Formulations.

| Components | C1 | Ex. #1 | Ex. #2 | Ex. #3 | Ex. #4 | Ex. #5 | Ex. #6 | Ex. #7 |
|---|---|---|---|---|---|---|---|---|
| Polyol A | 95 | 55 | 40 | 61.1 | 55 | 55 | 45 | |
| Polyol B | | 12.5 | 10 | | | | | 60 |
| Polyol C | | 20 | 25 | 11.1 | 20 | 20 | 30 | 20.9 |
| Polyol D | | 12.5 | 25 | 27.8 | 25 | 25 | 25 | |
| Polyol E | 5 | | | | | | | 20 |
| H₂O | 1.25 | 1.25 | 1.25 | 1.25 | 1.25 | 1.25 | 1.25 | 1.25 |
| Surfactant A | 0.9 | 0.9 | 0.9 | 0.9 | 0.9 | 0.9 | 0.9 | 0.9 |
| Amine | 0.15 | 0.15 | 0.15 | 0.15 | 0.15 | 0.15 | 0.15 | 0.15 |
| Catalyst A | | | | | | | | |
| Amine | 0.3 | 0.2 | 0.2 | 0.2 | 0.2 | 0.2 | 0.2 | 0.2 |
| Catalyst B | | | | | | | | |
| Tin Catalyst A | 0.03 | 0 | 0 | 0 | 0 | 0 | 0 | 0.01 |
| Total | 102.63 | 102.5 | 102.5 | 102.5 | 102.5 | 102.5 | 102.5 | 103.41 |
| Nominal | 90 | 95 | 95 | 90 | 90 | 95 | 100 | 90 |
| Index | | | | | | | | |
| TDI-80 | 33.3 | 36.0 | 36.9 | 36.5 | 24.7 | 36.6 | 36.8 | 33.3 |

TABLE 2
Properties of foams.

| Properties | C1 | Ex. #1 | Ex. #2 | Ex. #3 | Ex. #4 | Ex. #5 | Ex. #6 | Ex. #7 |
|---|---|---|---|---|---|---|---|---|
| Tensile | 5.65 | 6.29 | 2.26 | 4.91 | 1.58 | | 1.83 | 5.58 |
| Strength (psi) | | | | | | | | |
| % Elongation | 120 | 93 | 73 | 102 | 68 | | 52 | 112 |
| Tear Strength | 0.82 | 1.08 | 0.37 | 0.78 | 0.28 | | 0.33 | 0.83 |
| (lb_{f}/in) | | | | | | | | |
| Air Flow | 0.16 | 1.65 | 1.90 | 1.92 | 2.79 | 1.36 | 1.56 | 0.57 |
| (ft³/min) | | | | | | | | |
| Density (lb/ft³) | 3.95 | 3.79 | 3.60 | 3.82 | 3.96 | | 3.87 | 4.13 |
| CFD 25% (lb) | 3.33 | 4.56 | 1.61 | 2.23 | 1.01 | | 1.56 | 3.58 |
| CFD 65% (lb) | 7.07 | 10.04 | 4.93 | 5.88 | 3.76 | | 6.39 | 7.63 |
| CFD 75% (lb) | 13.12 | 18.67 | 9.85 | 11.3 | 7.96 | | 13.62 | 14.07 |
| Support | 2.12 | 2.2 | 3.06 | 2.63 | 3.72 | | 4.1 | 2.13 |
| Factor | | | | | | | | |
| Recovery | 4 | 2 | 12 | 4 | 43 | | 52 | 2 |
| Time (sec) | | | | | | | | |
| Resiliency | 3.6 | 8 | 12 | 8.8 | 9.2 | | 18 | 7 |
| (%) | | | | | | | | |
| Compression | 2.5 | 0.4 | 4.4 | 1.4 | 3.7 | | 6.0 | 1.2 |
| Set @ 75% | | | | | | | | |
| (%) | | | | | | | | |
| Compression | 2.7 | 0.4 | 5.1 | 1.7 | 5.0 | | 6.4 | 1.3 |
| Set @ 90% | | | | | | | | |
| (%) | | | | | | | | |

While the foregoing is directed to embodiments of the invention, other and further embodiments of the invention may be devised without departing from the basic scope thereof.

1. A reaction system for preparation of a viscoelastic polyurethane foam comprising:
(a) a toluene diisocyanate (TDI) component;
(b) an isocyanate reactive component comprising:
(i) from 70% to 90% by weight of the isocyanate reactive component of one or more propylene oxide rich (PO-rich) polyols having a combined number average equivalent weight from 300 to 500;
(ii) from 10% to 28% by weight of the isocyanate reactive component of one or more ethylene oxide rich (EO-rich) polyols having a combined number average equivalent weight from 100 to 500; and
(iii) from 1% to 5% by weight of the isocyanate reactive component of water; and
(c) a catalyst component.

2. The reaction system of claim 1, further comprising:
(d) an organosilicone surfactant.

3. The reaction system of claim 2, further comprising:
(e) an additive selected from the group consisting of chain extenders, crosslinkers, surfactants, plasticizers, fillers, plasticizers, smoke suppressants, fragrances, reinforcements, dyes, colorants, pigments, preservatives, odor masks, physical blowing agents, chemical blowing agents, flame retardants, internal mold release agents, biocides, antioxidants, UV stabilizers, antistatic agents, thixotropic agents, adhesion promoters, cell openers, and combination thereof.

4. The reaction system of claim 2, where the toluene diisocyanate component is a mixture of about 80 weight percent 2,4 TDI and 20 weight percent 2,6 TDI.

5. The reaction system of claim 2, wherein less than 28% of all polyoxyalkylene units on the polyols are oxyethylene units.

6. The reaction system of claim 2, wherein the isocyanate reactive component comprises:
one or more EO-rich polyols having a functionality of between 2 and 4 and a combined number averaged equivalent weight of between 100 and 300;
one or more PO-rich polyols having a functionality of between 2 and 4 and a combined number averaged equivalent weight of between 200 and 400; and
one or more glycerin initiated polyoxyethylene-polyoxypropylene polyols having a functionality of between 2 and 4 and a number averaged equivalent weight of between 800 and 1100.

7. The reaction system of claim 6, wherein the one or more PO-rich polyols comprises:
one or more PO-rich polyols having a functionality of 3 and a combined number averaged equivalent weight of between 300 and 350; and
one or more PO-rich polyols having a functionality of 3 and a combined number averaged equivalent weight of between 200 and 250.

8. The reaction system of claim 6 or 7, wherein less than 25% of all polyoxyalkylene units on the polyols are oxyethylene units.

9. The reaction system of claim 1, wherein the one or more catalysts are selected from amine catalysts and tin catalysts.

10. A method of preparing a viscoelastic foam, comprising:
forming a reaction mixture including:
a toluene diisocyanate (TDI) component;
an isocyanate reactive component comprising;
one or more propylene oxide rich (PO-rich) polyols having a combined number average equivalent weight from 300 to 500 comprising from 70% to 90% by weight of the isocyanate reactive component;
one or more ethylene oxide rich (E0-rich) polyols having a combined number average equivalent weight from 175 to 400 comprising from 10% to 28% by weight of the total isocyanate reactive component; and
water;
a catalyst component comprising at least one catalyst; and
subjecting the reaction mixture to conditions sufficient to result in the reaction mixture to expand and cure to form a viscoelastic polyurethane foam having a resilience of less than 25%, as measured according to ASTM D3574 Test H.

11. The method of claim 10, wherein the toluene diisocyanate component is a mixture of about 80 weight percent 2,4 TDI and 20 weight percent 2,6 TDI.

12. The method of claim 10, wherein the isocyanate reactive component comprises:
one or more EO-rich polyols having a functionality of between 2 and 4 and a combined number averaged equivalent weight of between 100 and 300;
one or more PO-rich polyols having a functionality of between 2 and 4 and a combined number averaged equivalent weight of between 200 and 400; and
one or more glycerin initiated polyoxyethylene-polyoxypropylene polyols having a functionality of between 2 and 4 and a combined number averaged equivalent weight of between 800 and 1100.

13. The method of claim 12, wherein the one or more PO-rich polyols comprises:
one or more polyoxypropylene based polyols having a functionality of 3 and a combined number averaged equivalent weight of between 300 and 350; and
one or more polyoxypropylene based polyols having a functionality of 3 and a combined number averaged equivalent weight of between 200 and 250.

14. The method of claim 12, wherein the viscoelastic foam has an air flow of at least about any of 0.6, 0.7, 0.8, 0.9, or 1.3 liters/second and a compression set @ 75% of less than 5%.

15. The method of claim 12, wherein less than 25% of all polyoxyalkylene units on the polyols are oxyethylene units.
